(19) United States
(12) Patent Application Publication
(10) Pub. No.: US 2005/0199009 A1
(43) Pub. Date: Sep. 15, 2005

(54) Method for recyling glass

(76) Inventor: Joe Lee, Taichung Hsien (TW)

Correspondence Address: BRINKS HOFER GILSON & LIONE, NBC Tower, Suite 3600, 455 N. Cityfront Plaza Drive, Chicago, IL, 60611-5599, US

(21) Appl. No.: 10/801,018

(22) Filed: Mar. 15, 2004

(51) Int. Cl. C03B 23/00

(52) U.S. Cl. 65/21.3; 65/28; 65/23; 65/65

(57) ABSTRACT

A method for recycling glass includes the steps of: (a) mixing glass shards with carbon powders so as to permit adhesion of the carbon powders to the surface of each glass shard, (b) heating the glass shards so as to melt the surface of each glass shards, (c) cooling the heated glass shards, and (d) removing the carbon powders from the glass shards.

### BACKGROUND OF THE INVENTION

1. Field of the Invention

This invention relates to a method for recycling glass, particularly to a method for recycling glass so as to manufacture irregularly shaped shiny glass shards with round edges.

2. Description of the Related Art

In general, a process for recycling waste glass includes the steps of: sorting the waste glass according to color; removing contaminants, such as foil or paper labels, chemical adhesives and non-recyclable refuse, from the surface of the waste glass; crushing the waste glass to form glass shards; and completely melting the glass shards in a melting furnace so as to form a liquid glass slurry. Thereafter, the liquid glass slurry is poured into a suitable mold, which is subsequently cooled so as to form a recycled glass material with a desired shape.

The conventional method is disadvantageous in that it involves complete melting of the glass shards in order to recycle glass.

### SUMMARY OF THE INVENTION

Therefore, the object of this invention is to provide a method for recycling glass that does not involve the complete melting of glass shards as required in the prior art.

According to this invention, a method for recycling glass includes the steps of: (a) mixing glass shards with carbon powders so as to permit adhesion of the carbon powders to the surface of each glass shard; (b) heating the glass shards so as to melt the surface of each glass shard; (c) cooling the heated glass shards; and (d) removing the carbon powders from the glass shards.

### BRIEF DESCRIPTION OF THE DRAWINGS

Other features and advantages of the present invention will become apparent in the following detailed description of the preferred embodiment of the invention, with reference to the accompanying drawings. In the drawings:

FIG. 1 is a flow chart to illustrate consecutive steps of the preferred embodiment of a method for recycling glass according to this invention;

FIG. 2 is a schematic perspective view to illustrate a recycle system suitable for recycling glass according to the method of this invention;

FIG. 3 is a schematic view to illustrate how glass shards are processed using the recycle system shown in FIG. 2 according to the method of this invention;

FIG. 4 is a schematic view to illustrate the structure of a conveying drum of the recycle system shown in FIG. 2;

FIG. 5 is a curve plot to illustrate heat processing of the glass shards in the recycle system shown in FIG. 2; and

FIG. 6 is a schematic view of a tile formed from cement and the glass shards obtained from the method of the preferred embodiment of this invention.

### DETAILED DESCRIPTION OF THE PREFERRED EMBODIMENT

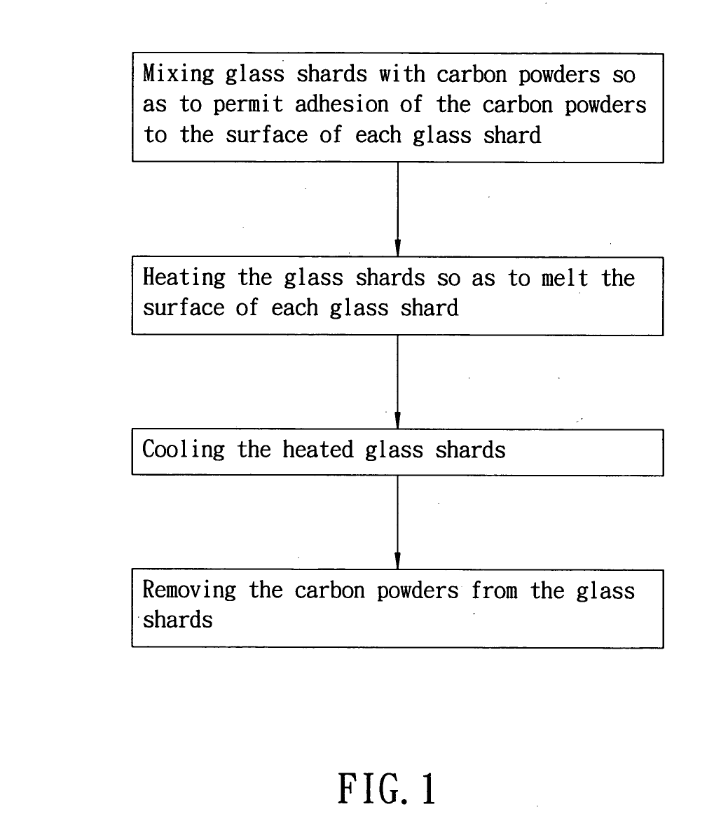

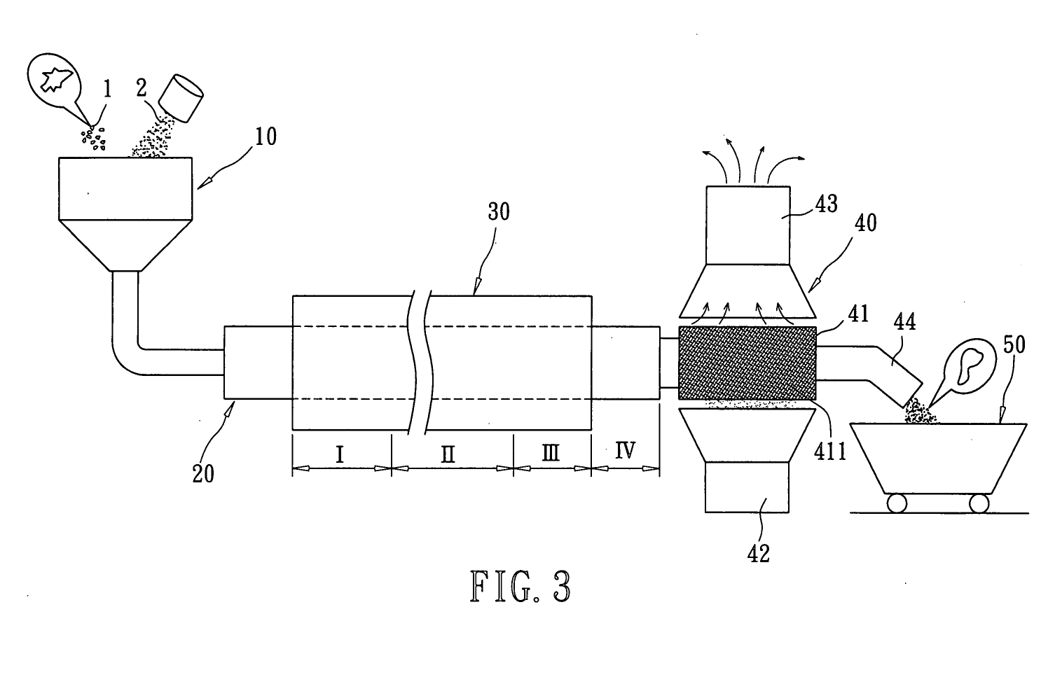

Referring to FIGS. 1 and 3, the preferred embodiment of a method for recycling glass according to this invention includes the steps of: mixing glass shards 1 with carbon powders 2 so as to permit adhesion of the carbon powders 2 to the surface of each glass shard 1; heating the glass shards 1 so as to melt the surface of each glass shard 1; cooling the heated glass shards 1; and removing the carbon powders 2 from the glass shards 1. The heat processing of the glass shards 1 permits conversion of sharp edges of each glass shard 1 into round edges. The glass shards 1 may be further post-treated, such as cleaning, so as to result in irregularly shaped shiny glass shards 1.

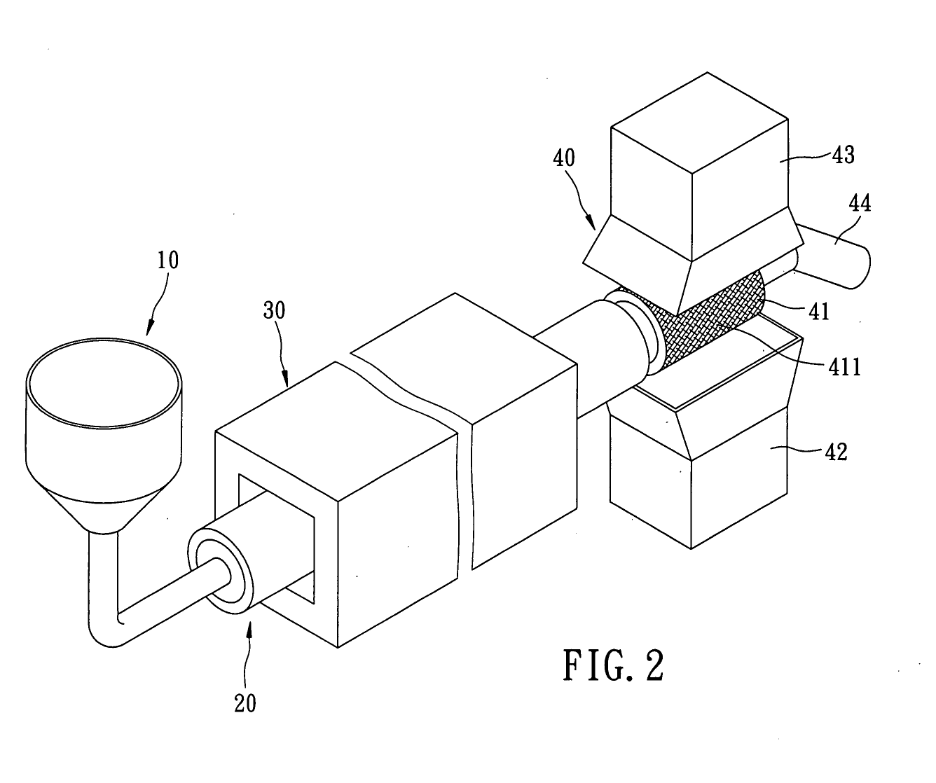

Referring to FIG. 2, the recycle system suitable for recycling glass according to the method of this invention includes: a mixing tank 10; a conveying drum 20 having a first end portion that is connected to the mixing tank 10 and a second end portion that is opposite to the first end portion; a heating furnace 30 that is sleeved on the conveying drum 20 between the first and second end portions; and a particle-removing unit 40 that is connected to the second end portion of the conveying drum 20.

Preferably, the particle-removing unit 40 includes a dust-collecting member 43, a carbon powder collector 42, and a screen barrel 41 that is disposed between the dust-collecting member 43 and the carbon powder collector 42 and that has a peripheral screen wall 411 with two ends connected to the second end portion of the conveying drum 20 and an outlet pipe 44, respectively.

With further reference to FIG. 3, the conveying drum 20 includes four heat-treatment sections, namely, a first heating section (I), a second heating section (II), a first cooling section (III) and a second cooling section (IV), which are disposed sequentially along the length of the conveying drum 20 from the first end portion to the second end portion. The first heating section (I), the second heating section (II) and the first cooling section (III) are disposed in the heating furnace 30. The second cooling section (IV) is disposed outside of the heating furnace 30. In addition, the recycle system includes a glass shard collector 50 for collecting the glass shards that exit the outlet pipe 44.

In this embodiment, the glass shards 1 and the carbon powders 2 are first poured into the mixing tank 10. The glass shards 1 and the carbon powders 2 are mixed together in the mixing tank 10 so as to permit adhesion of the carbon powders 2 to the surface of each glass shard 1.

The glass shards 1 are obtained from crushed waste glass material that has been pre-treated by sorting according to the color thereof and by removing containments from the crushed waste glass material. Alternatively, the glass shards 1 may be obtained from commercially available waste glass pellets.

Preferably, the weight ratio of the glass shards 1 to the carbon powders 2 ranges from 200:1 to 50:1. More preferably, the weight ratio of the glass shards 1 to the carbon powders 2 ranges from 110:1 to 90:1. Most preferably, the weight ratio of the glass shards 1 to the carbon powders 2 is 100:1.

The carbon powders 2 employed in the method of this invention have a function of separating the glass shards 1 from each other so as to prevent fusion of the glass shards 1.

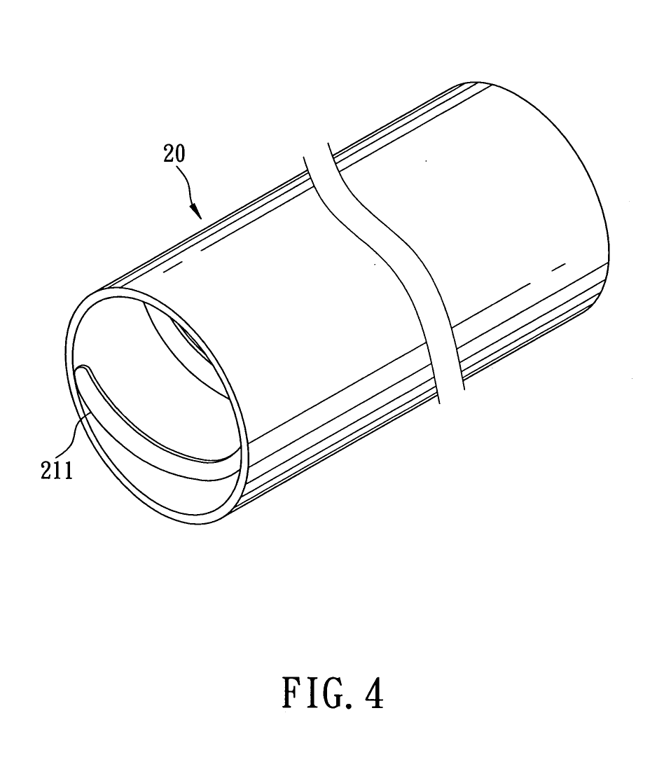

After mixing the irregularly shaped glass shards 1 and the carbon powders 2 in the mixing tank 10, the heating operation and the cooling operation for the glass shards 1 are conducted by conveying the glass shards 1 through the heating furnace 30 using the conveying drum 20. With further reference to FIG. 4, spiral vanes 211 are disposed along an inner wall surface of the conveying drum 20 so as to convey the glass shards 1 through the heating furnace 30 toward the particle-removing unit 40. The conveying drum 20 is driven by a motor (not shown) in order to control the heating time of the glass shards 1 in the conveying drum 20. For example, when a 6 m conveying drum 20 is used, and when the conveying drum 20 rotates at a rotating speed ranging from 4 rpm to 10 rpm, a moving speed ranging approximately from 0.3 m/min to 2 m/min for the glass shards 1 in the conveying drum 20 and a heat heat-treatment time ranging from 2 to 12 minutes for the glass shards 1 in the heating furnace 30 can be achieved.

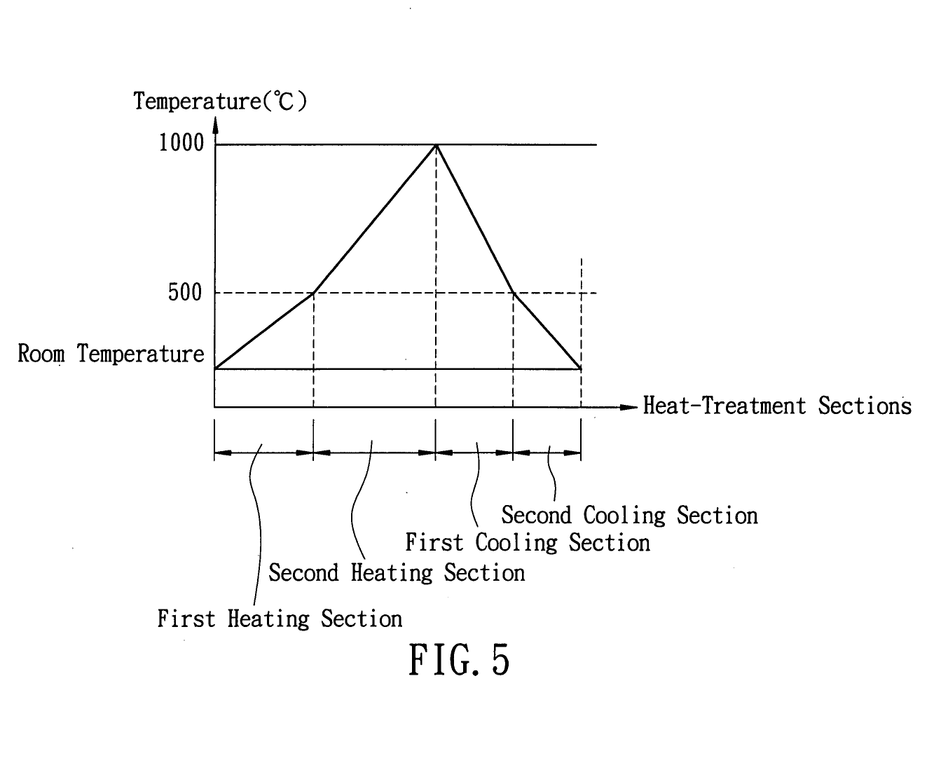

During the heating operation and the cooling operation for the glass shards 1, as shown in FIGS. 3 and 5, the glass shards 1 are pre-heated from room temperature to 500° C. in the first heating section (I), are then heated from 500° C. to 1000° C. in the second heating section (II) for melting the surface of each glass shard 1 so as to convert sharp edges of each glass shard 1 into round edges, are then cooled from 1000° C. to 500° C. in the first cooling section (III), and are further cooled from 500° C. to room temperature in the second cooling section (IV) for quenching and hardening the glass shards 1.

After the heating operation and cooling operation for the glass shards 1, the glass shards 1 are transported to the particle-removing unit 40 for removing the carbon powders 2 from the glass shards 1. The peripheral screen wall 411 of the screen barrel 41 has a mesh size smaller than the particle size of the glass shards 1 but larger than the particle size of the carbon powders 2. Hence, the carbon powders 2 can be removed from the glass shards 1 through frictional contact between the glass shards 1 and the peripheral screen wall 411 of the screen barrel 41. The carbon powders 2 removed from the glass shards 1 are collected in the carbon powder collector 42 for recycle. Removal of carbon powders 2 from the glass shards 1 is further enhanced by the dust-collecting member 43. After removal of the carbon powders 2, the glass shards 1 are discharged from the particle-removing unit 40 through the outlet pipe 44, and are collected in the glass shard collector 50.

The glass shards 1 collected in the glass shard collector 50 may be post-treated through cleaning, sorting according to their particle sizes, and packing so as to provide an irregularly shaped shiny glass shard product 1.

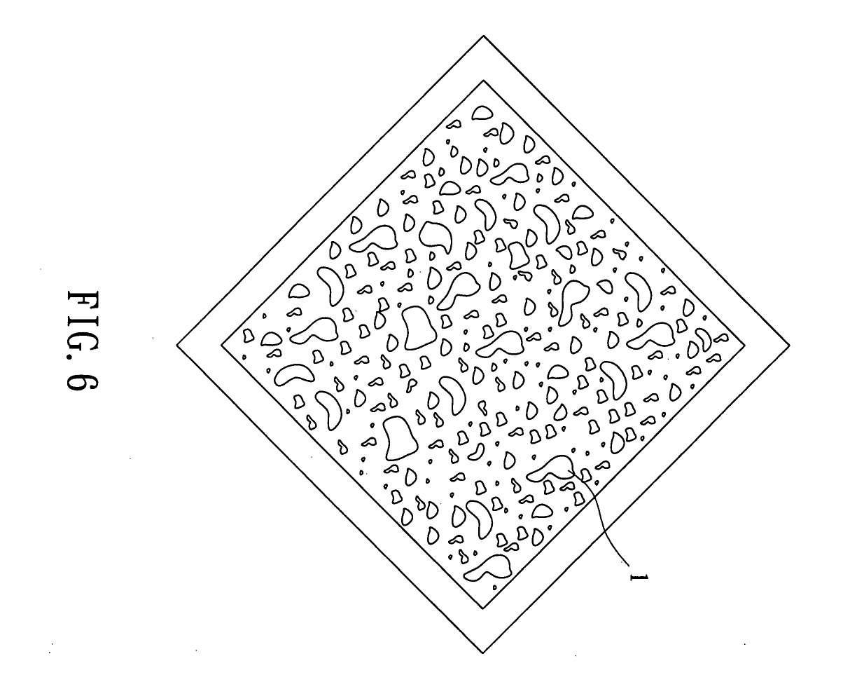

Since the irregularly shaped shiny glass shard product 1 obtained from the method of this invention is fire-retardant, water-resistant, dust-proof and stable, it is suitable for architectural applications. For example, as shown in FIG. 6, the irregularly shaped shiny glass shard product 1 may be inlaid in a cement tile for architectural use. The irregularly shaped shiny glass shard product may be inlaid in other architectural material, such as sheet glass or wood planks, so as to improve the hardness and strength of the architectural material. In addition, the irregularly shaped shiny glass shard product 1 of this invention maybe used in ornamental applications, such as decorations on a wall or a floor of buildings or swimming pools, garden design, and decorations for pottery, aquariums or handcrafts, so as to increase consumer appeal.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. A method for recycling glass, comprising the steps of:
(a) mixing glass shards with carbon powders so as to permit adhesion of the carbon powders to the surface of each glass shard;
(b) heating the glass shards so as to melt the surface of each glass shard;
(c) cooling the heated glass shards; and
(d) removing the carbon powders from the glass shards.

2. The method of claim 1, wherein the weight ratio of the glass shards to the carbon powders ranges from 110:1 to 90:1.

3. The method of claim 2, wherein the weight ratio of the glass shards to the carbon powders is 100:1.

4. The method of claim 1, wherein steps (b) and (c) are conducted by conveying the glass shards through a heating furnace using a conveying drum.

5. The method of claim 4, wherein, in sequence, the glass shards are heated from room temperature to 500° C., are heated from 500° C. to 1000° C., are cooled from 1000° C. to 500° C., and are cooled from 500° C. to the room temperature.
